(19) United States
(12) Patent Application Publication
(10) Pub. No.: US 2024/0089273 A1
(43) Pub. Date: Mar. 14, 2024

(54) SYSTEMS, METHODS, AND DEVICES FOR RISK AWARE AND ADAPTIVE ENDPOINT SECURITY CONTROLS

(71) Applicant: SentinelOne, Inc., Mountain View, CA (US)

(72) Inventor: Milad-Can Aslaner, Dubai (AE)

(21) Appl. No.: 18/464,202

(22) Filed: Sep. 9, 2023

Related U.S. Application Data
(60) Provisional application No. 63/375,200, filed on Sep. 9, 2022.

(51) Int. Cl. H04L 9/40

(52) U.S. Cl. CPC H04L 63/1416; H04L 63/1425; H04L 63/20

(57) ABSTRACT

A computer-implemented method may include detecting, by an agent running on a first computing system, information indicative of a security threat, wherein the first computing system is operating with a first security policy. A method may include sending, from the first computing system to a second computing system via a network connection, an indication of the security threat. A method may include receiving, by the first computing system from the second computing system via the network connection, an indication of a second security policy to apply. A method may include applying, by the agent, the second security policy to the first computing system.

### INCORPORATION BY REFERENCE TO ANY PRIORITY APPLICATIONS

Any and all applications for which a foreign or domestic priority claim is identified in the Application Data Sheet as filed with the present application are hereby incorporated by reference under 37 CFR 1.57. This application claims the benefit of priority under 35 U.S.C. § 119 to U.S. Provisional Patent Application No. 63/375,200, titled “SYSTEMS, METHODS, AND DEVICES FOR RISK AWARE AND ADAPTIVE ENDPOINT SECURITY CONTROLS,” filed Sep. 9, 2022, the contents of which are hereby incorporated by reference in their entirety and for all purposes as if fully set forth herein.

### BACKGROUND

### Field

Some embodiments herein are generally directed to threat detection and security of computer endpoint systems.

### Description

Historically, endpoint security policies have been static and, once configured, remain unchanged. As a result, when an endpoint is compromised, the attack surface remains open until a human analyst or artificial intelligence (AI) performs remedial actions. The attack surface can be the number of all possible points, or attack vectors, where an unauthorized user can access a system and extract data. Accordingly, novel systems, methods, and devices for endpoint prevention policies are needed.

### SUMMARY

For purposes of this summary, certain aspects, advantages, and novel features of the invention are described herein. It is to be understood that not all such advantages necessarily may be achieved in accordance with any particular embodiment of the invention. Thus, for example, those skilled in the art will recognize that the invention may be embodied or carried out in a manner that achieves one advantage or group of advantages as taught herein without necessarily achieving other advantages as may be taught or suggested herein.

In some aspects, the techniques described herein relate to a computer-implemented method for automatically applying a security policy in response to a security threat including: detecting, by an agent running on a first computing system, information indicative of a security threat, wherein the first computing system is operating with a first security policy; sending, from the first computing system to a second computing system via a network connection, an indication of the security threat; receiving, by the first computing system from the second computing system via the network connection, an indication of a second security policy to apply; and applying, by the agent, the second security policy to the first computing system.

In some aspects, the techniques described herein relate to a computer-implemented method, further including: determining, by the agent running on the first computing system, that the security threat has been eliminated; sending, from the first computing system to the second computing system via the network connection, an indication that the security threat has been eliminated; receiving, by the first computing system from the second computing system via the network connection, an indication to apply the first security policy; and applying, by the agent on the first computing system, the first security policy.

In some aspects, the techniques described herein relate to a computer-implemented method, wherein the indication of the second security policy to apply includes the second security policy.

In some aspects, the techniques described herein relate to a computer-implemented method, wherein the indication of the second security policy to apply includes an identifier of the second security policy, wherein the second security policy is stored on the first computing system.

In some aspects, the techniques described herein relate to a computer-implemented method, wherein the information indicative of a security threat includes information indicative of a first security threat and information indicative of a second security threat, wherein the second security policy is generated by the second computing system based on a third security policy associated with the first security threat and a fourth security policy associated with the second security threat.

In some aspects, the techniques described herein relate to a computer-implemented method, wherein the second security policy includes a group policy object.

In some aspects, the techniques described herein relate to a computer-implemented method, wherein the information indicative of the security threat includes monitoring data, and wherein the second computing system is configured to analyze the monitoring data and determine that a security threat is present on the first computing system.

In some aspects, the techniques described herein relate to a computer-implemented method, wherein the information indicative of the security threat includes an indication that the agent has detected a security threat on the first computing system, wherein the agent is configured to analyze monitoring data and determine that a security threat is present on the first computing system.

In some aspects, the techniques described herein relate to a computer-implemented method for automatically applying a security policy in response to a security threat including: receiving, by a first computing system from a second computing system via a network connection, information indicative of a security threat present on the second computing system, wherein the second computing system is operating with a first security policy; determining, by the first computing system, a second security policy to apply on the second computing system; and sending, from the first computing system to the second computing system via the network connection, an indication of the second security policy to apply.

In some aspects, the techniques described herein relate to a computer-implemented method, further including: receiving, by the first computing system from the second computing system via the network connection, an indication that the security threat has been eliminated; and sending, from the first computing system to the second computing system via the network connection, an indication to apply the first security policy.

In some aspects, the techniques described herein relate to a computer-implemented method, wherein the indication of the second security policy to apply includes the second security policy.

In some aspects, the techniques described herein relate to a computer-implemented method, wherein the indication of the second security policy to apply includes an identifier of the second security policy, wherein the second security policy is stored on the second computing system.

In some aspects, the techniques described herein relate to a computer-implemented method, wherein the information indicative of a security threat includes information indicative of a first security threat and information indicative of a second security threat, wherein the computer-implemented method further includes: determining, by the first computing system, a third security policy in response to the first security threat; determining, by the first computing system, a fourth security policy in response to the second security threat; and generating, by the first computing system, the second security policy based on the third security policy and the fourth security policy.

In some aspects, the techniques described herein relate to a computer-implemented method, wherein the second security policy includes a group policy object.

In some aspects, the techniques described herein relate to a computer-implemented method, wherein the information indicative of the security threat includes monitoring data, and wherein the first computing system is configured to analyze the monitoring data and determine that a security threat is present on the second computing system.

In some aspects, the techniques described herein relate to a computer-implemented method, wherein the information indicative of the security threat includes an indication that an agent running on the second computing system has detected a security threat on the second computing system, wherein the agent is configured to analyze monitoring data and determine that a security threat is present on the second computing system.

In some aspects, the techniques described herein relate to a computer-readable medium storing instructions that, when executed by a computer, cause the computer to perform a method including: detecting, by an agent running on a first computing system, information indicative of a security threat, wherein the first computing system is operating with a first security policy; sending, from the first computing system to a second computing system via a network connection, an indication of the security threat; receiving, by the first computing system from the second computing system via the network connection, an indication of a second security policy to apply; and applying, by the agent, the second security policy to the first computing system.

In some aspects, the techniques described herein relate to a computer-readable medium, wherein the method further includes: determining, by the agent running on the first computing system, that the security threat has been eliminated; sending, from the first computing system to the second computing system via the network connection, an indication that the security threat has been eliminated; receiving, by the first computing system from the second computing system via the network connection, an indication to apply the first security policy; and applying, by the agent on the first computing system, the first security policy.

In some aspects, the techniques described herein relate to a computer-readable medium, wherein the information indicative of the security threat includes monitoring data, and wherein the second computing system is configured to analyze the monitoring data and determine that a security threat is present on the first computing system.

In some aspects, the techniques described herein relate to a computer-readable medium, wherein the information indicative of the security threat includes an indication that the agent has detected a security threat on the first computing system, wherein the agent is configured to analyze monitoring data and determine that a security threat is present on the first computing system.

### BRIEF DESCRIPTION OF THE DRAWINGS

The drawings are provided to illustrate example embodiments and are not intended to limit the scope of the disclosure. A better understanding of the systems and methods described herein will be appreciated upon reference to the following description in conjunction with the accompanying drawings, wherein:

FIG. 1 illustrates a flowchart of an example conditional policy implementation according to some embodiments herein.

FIG. 2 illustrates an example of automated security policy assignment according to some embodiments.

FIG. 3 is a flowchart that illustrates an example process for automatic security policy changes according to some embodiments.

FIG. 4 illustrates an example process that can take place between and endpoint and a cloud service according to some embodiments.

FIG. 5 illustrates an example process that can be run by an agent on a computing system such as an endpoint, server, identity server, etc., according to some embodiments.

FIG. 6 is a block diagram depicting an embodiment of a computer hardware system configured to run software for implementing one or more embodiments disclosed herein.

### DETAILED DESCRIPTION

Although certain preferred embodiments and examples are disclosed below, inventive subject matter extends beyond the specifically disclosed embodiments to other alternative embodiments and/or uses and to modifications and equivalents thereof. Thus, the scope of the claims appended hereto is not limited by any of the particular embodiments described below. For example, in any method or process disclosed herein, the acts or operations of the method or process may be performed in any suitable sequence and are not necessarily limited to any particular disclosed sequence. Various operations may be described as multiple discrete operations in turn, in a manner that may be helpful in understanding certain embodiments; however, the order of description should not be construed to imply that these operations are order dependent. Additionally, the structures, systems, and/or devices described herein may be embodied as integrated components or as separate components. For purposes of comparing various embodiments, certain aspects and advantages of these embodiments are described. Not necessarily all such aspects or advantages are achieved by any particular embodiment. Thus, for example, various embodiments may be carried out in a manner that achieves or optimizes one advantage or group of advantages as taught herein without necessarily achieving other aspects or advantages as may also be taught or suggested herein.

Certain exemplary embodiments will now be described to provide an overall understanding of the principles of the structure, function, manufacture, and use of the devices and methods disclosed herein. One or more examples of these embodiments are illustrated in the accompanying drawings. Those skilled in the art will understand that the devices and methods specifically described herein and illustrated in the accompanying drawings are non-limiting exemplary embodiments and that the scope of the present invention is defined solely by the claims. The features illustrated or described in connection with one exemplary embodiment may be combined with the features of other embodiments. Such modifications and variations are intended to be included within the scope of the present technology.

As used herein, the term “endpoint” can refer to desktops, laptops, tablets, mobile phones, Internet of Things (IoT) devices, and/or other devices that connect to a network. Unless context clearly dictates otherwise, endpoints can include any of the aforementioned devices as well as, for example and without limitation, servers, clusters, virtual machines, domain controllers, identity servers, and so forth.

Some embodiments herein are directed to conditional computer endpoint security policies and risk-based security enforcement. In some embodiments, modern computer security systems can continuously balance security, the open attack surface, and the user experience. Organizations may take measures to continuously monitor their attack surface to prevent, detect, and/or remediate threats as quickly as possible. Organizations may make efforts minimize the attack surface area to reduce the risk of cyberattacks succeeding. However, doing so becomes difficult as organizations expand their digital footprint and embrace new technologies, while maintaining a satisfactory end-user experience. The digital attack surface area encompasses all the hardware and software that connects to an organization's network. Attack surfaces can include, for example and without limitation, applications, code, network ports, servers, web browsers, among others. The physical attack surface can include all endpoint devices that an attacker can gain physical access to, such as desktop computers, hard drives, laptops, mobile phones, Universal Serial Bus (USB) drives, SD cards, servers, etc. The physical attack threat surface can include, for example, carelessly discarded hardware that contains user data and/or login credentials, misplaced flash storage devices, passwords written on paper, and physical break-ins.

When security system enforcements, such as security policies, are too strong, the attack surface can be reduced, but end user productivity can be adversely affected. In some cases, users may become frustrated and attempt to work around security policies. For example, users may perform work on their personal devices and then email files to their work email addresses or use USB drives, cloud services, etc., to store work-related files so that they can be accessed from a work computer or other computers that are not managed by an organization, such as personal computers, personal smartphones (e.g., accessed outside of managed applications on a smartphone), personal tablets, etc. Conversely, when security enforcements are too weak, end users may be more effective, but the open attack surface can be significantly larger. As a result, many organizations struggle to achieve a good balance of security and productivity. In some cases, organizations may enforce light security policies to ensure that users can do their work efficiently.

In some conventional approaches, security threat prevention, detection, and response may be different processes. For example, in some cases, one application or platform may be used for prevention and detection, but that application or platform may not be involved in remediation. In some cases, this can mean that an endpoint or other computing system can remain operational while awaiting remediation, which can leave the organization open to further damage (e.g., data may continue to be exfiltrated, files may continue to be encrypted, deleted, etc., malware may propagate throughout an organization's network, etc.).

Generally, detection/preventions measures and remediation measures are separate. Thus, there can be a significant time period between when a threat is identified and when action is taken to remediate the threat. In some embodiments, some limited immediate actions can be taken, such as terminating a process, quarantining a file, or limiting network activity, but such measures are generally static and not configurable based on the specific threat type. Thus, in some cases, such measures may be poorly suited to addressing the threat at hand, may take overly draconian steps that interfere with the operation of a computing system, and so forth.

When organizations use lightweight prevention policies, they may depend on other security controls to detect and/or respond to security threats. Delays in response can leave an attack surface open. Any and all organizations are capable of being breached, and many organizations cannot address all security alerts promptly. For example, it may take several hours, several days, or even several weeks or months for an organization to respond to a security alert. During this time, a vulnerable device may continue to operate on the organization's network, potentially compromising network stability, data security, etc.

According to some embodiments herein, organizations can automatically reduce the open attack surface while an endpoint is under threat. That is, unlike conventional approaches that separate response and remediation from prevention and detection, some embodiments herein can bridge these so that prevention measures are taken in response to a security threat even before a security analyst or other information technology professional addresses the security threat. Some embodiments herein are directed to a policy engine that is risk-aware and can perform adaptive security control changes as threats appear on an endpoint. In some embodiments, the policy engine is configured to implement security policies that are situationally aware and automatically increase or decrease security enforcement depending upon an endpoint's status. As such, some embodiments herein allow organizations to make risk-based policy decisions. By contrast, conventional security technologies do not provide sufficient flexibility to make risk-based decisions that would help increase or decrease security enforcements to strike a good balance among security, open attack surface, and end-user productivity.

In some embodiments, the conditional policy engine may be implemented within a zero-trust network (ZTN) strategy in which organizations protect against, detect, respond to, and recover from cyber threats. In a ZTN security strategy, every user, endpoint, application, workload, and data flow may be treated as untrusted. Furthermore, in a ZTN implementation, systems can operate with the assumption that an adversary already has a presence within the environment, and access can be controlled in a consistent manner using multiple trust signals for contextual access decisions. In some embodiments, implementing a conditional policy engine within a ZTN makes it possible to evaluate the health state of endpoints and adjust security enforcements dynamically based on that state. In some embodiments, the conditional policy engine may be a component of an agent that runs on a computing system being monitoring (e.g., an endpoint, a server, etc.). In some embodiments, the conditional policy engine may be a component of a cloud service. For example, in such an approach, the conditional policy engine can receive information from an agent running on a monitored device and can instruct the agent to apply a particular security policy.

In some embodiments, organizations may define, via a user interface (e.g., a graphical user interface, a command line interface, etc.), via an API, or both, security profiles for healthy endpoints or groups of endpoints and define different security profiles for risky and/or compromised endpoints or groups of endpoints. In some embodiments, organizations may define multiple security policies. For example, an appropriate security response may vary depending on the type of security threat, such as a physical attack, ransomware attack, trojan attack, etc. In some embodiments, the conditional policy engine can empower organizations to dynamically change security policies based on a current risk level of an endpoint (e.g., whether or not a threat has been detected, the type of threat detected, and so forth). In some embodiments, when implemented within a ZTN, endpoints may not be trusted by default and may be continuously verified for their health state, such that the security policies in place may be dynamically and automatically changed based on a detected health state. In some embodiments, when an active threat is detected to impact a protected endpoint, the conditional policy engine may temporarily redefine the endpoint as a risky/compromised endpoint and adjust the endpoint security policy to the policy defined for a risky and/or compromised endpoint within the security configuration. In some embodiments, once a threat has been remediated, the endpoint may be redefined as a healthy endpoint and assigned policies based on the security configuration of a healthy endpoint. Thus, the conditional policy engine may facilitate reduction in the attack surface and prevent potential further damage to the endpoint, other endpoints, and/or the network. For example, an endpoint that is compromised may be transitioned automatically from a default security policy to a compromised security policy. In some cases, the endpoint may still be usable but may have restricted or limited functionality. Thus, for example, a user may be able to continue using the endpoint while a security team investigates and works to resolve the security issue, but the endpoint may be limited such that further damage to the endpoint itself and/or to other devices on the same network as the endpoint is limited. Once the security issue is resolved, the endpoint may be automatically transitioned back to its default security policy.

In some embodiments, as an example, by default, a security profile may allow endpoints to use USB thumb drives. connect unrestricted to the internet, etc. However, when an endpoint is determined to be at risk and/or compromised, the conditional policy engine capability enables dynamic policy changes that allow the organization to reduce the attack surface while an artificial intelligence/machine learning (AI/ML) or human analyst responds to the threat. In some embodiments, once the threat is remediated, this capability can automatically revert to the default security policies.

In some embodiments, the conditional policy engine may enable an organization to define security baseline prevention and breach response policies and to utilize the policy engine to apply the relevant policy based on the risk level associated with an endpoint. As noted above, traditionally, organizations build and maintain static prevention security policies. There are no means for organizations to dynamically change security controls based on the risk level of an endpoint. However, according to some embodiments herein, organizations may automatically reduce the open attack surface during an incident. Instead of waiting for a security analyst to respond to a detected threat, organizations can, in an automated manner, reduce the attack surface dynamically, making it difficult for a threat actor to proceed with their attack.

In some embodiments, the conditional policy engine may increase security enforcements in real-time for compromised endpoints. In some embodiments, the conditional policy engine may continuously monitor all protected endpoints and increase security enforcements in real-time for compromised endpoints. In some embodiments, the conditional policy engine may integrate within a ZTN concept. In some embodiments, the conditional policy engine ensures that endpoints are not treated equal regardless of their compromised status. Instead, the conditional policy engine may enable a proactive approach to prevention policies. Rather than a static security enforcement, the conditional policy engine may enable proactive and conditional policy changes to specific endpoints based on status. In some traditional approaches, when an agent running on an endpoint detects a security threat, such as malware, attempts at unauthorized remote access, attempts at unauthorized local access, etc., it may quarantine the compromised endpoint and generate a ticket to an organization's information technology team. However, this can create a high influx of tickets to the information technology team, and the team may lack capacity to investigate the threat and take action immediately. In some embodiments, the agent may communicate with a cloud-based security service when it detects suspicious or malicious activity or otherwise compromised endpoints. In some embodiments, an agent may send monitoring data (e.g., endpoint detect and response (EDR) data, other telemetry data, etc.) to the cloud service for analysis, and the cloud service may determine if a security threat is present. Such a detection may result in the cloud service directing the agent to terminate a process, quarantine a suspicious file, and/or restrict network access. As described herein, such an approach can be detrimental to productivity and may render a computing system inoperable or unusable for an extended period of time while waiting on a team to respond to the security threat. As mentioned above, in some cases, such measures may be overly draconian, may fail to contain the security threat, or both.

A better approach, as described herein, can be to automatically enforce appropriate security policies based on the status of a computing system. For example, when a security threat is detected, an agent running on the computing system can automatically transition the system to a different security policy and can automatically transition the system back to a previous or default security policy once the threat is resolved. Such an approach can provide a more seamless experience for end users while protecting the organization against security threats. In some embodiments, security policies may be stored on the computing system, and the cloud service may provide an identifier indicating which security policy to apply. In some embodiments, security policies may be stored on the cloud service, and the cloud service may send a selected security policy to the agent to be applied the computing system. In some embodiments, for example for computing systems running the Windows operating system, the security policy can include a group policy object which can define one or more group policies that can be used to control or limit actions that can be taken by a user on the computing system.

In some embodiments, an agent can send data (e.g., enterprise detection and response (EDR) data, telemetry, etc.) to a cloud service for processing. In some embodiments, the cloud service can process the data and determine that a security threat is present on a computing system on which the agent is running. In some embodiments, the cloud service can instruct the agent transition the system to a second security policy, for example to quarantine the system, to prevent further malicious actions from taking place on the system, etc. In some embodiments, the cloud service can dynamically assign policies to comprised systems. In some embodiments, once the system is corrected and healthy, the agent can automatically revert back to the original security policy. In some embodiments, the system can switch between security policies automatically (e.g., without the intervention of a human). For example, when the system is detected as being in a compromised state (e.g., due to a physical attack, malware, etc.), an endpoint may transition from a first security policy to a second security policy without manual intervention by a security analyst or other member of an information technology team.

In some embodiments, an agent can automatically transition a system between two security policies. In some embodiments, an agent can automatically transition a system between more than two security policies. For example, in some embodiments, a compromised system can transition between three security policies. For example, if an agent detects a security threat on a system, the system may be automatically transitioned to a second security policy with enhanced monitoring, more restricted permissions, etc. In some embodiments, the agent may cause the system to transition to a third security policy. For example, if continued malicious behavior is detected after applying the second security policy, this may indicate that further actions are warranted, such as increased restrictions, different restrictions, or even completely disabling the system. In some embodiments, if the system is subsequently determined to be healthy (e.g., a security threat is no longer detected), the system can return to the original security policy. In some embodiments, the system can transition to a third security policy, for example a policy with enhanced monitoring as compared to a default security policy.

In some embodiments, the agent can provide a “heartbeat” every few seconds to the cloud service, reporting whether an endpoint is compromised and/or providing data that allows the cloud service to determine if the endpoint is compromised. In some embodiments, if the agent is unable to communicate with the cloud service, then the agent can enforce a locally-stored security policy until it is able to contact the cloud service. In some embodiments, an organization may direct which features of the device may be shut down or otherwise restricted by the agent. For example, the client organization may direct the agent to disable USB ports or limit USB port functionality (e.g., keyboards and mice may continue to work, while removable storage may not).

As described herein, a security policy can involve various actions. For example, in some embodiments, an agent can enforce policies for Wi-Fi (e.g., limiting Wi-Fi networks to which a system can connect), USB devices (e.g., enabling or disabling USB ports, allowing access by certain devices but not others (e.g., based on Vendor ID, Product ID, etc.), SD cards, Bluetooth devices (e.g., enabling or disabling Bluetooth, limiting devices that can connect, etc.), ethernet, Thunderbolt devices, Airdrop, Wi-Fi Direct, printing, reading from external storage media, writing to external storage media, etc. In some embodiments, a security policy can enforce policies relating to file reading/writing (e.g., to prevent the exfiltration of data, to prevent malware from corrupting or encrypting files, etc.), network access (e.g., restricting certain ports, restricting access to one or more URLs, IP addresses, etc.). In some embodiments, the security policy can block certain web sites, prevent certain applications from being run, blacklist certain web sites, email addresses, domains, etc., and so forth.

In some embodiments, the systems and methods herein can operate on various computing systems. For example, in some embodiments, the systems and methods herein can operate on one or more desktops, laptops, smartphones, local servers, cloud servers, public clouds, private clouds, virtual machines, containers, Kubernetes clusters, identity servers (e.g., Active Directory, Azure AD Domain Controllers, LDAP servers, or other domain-joined assets), Internet of Things (IoT) devices, etc.

In some embodiments, the systems and methods described herein can involve an agent running on a system and a cloud service. In some embodiments, the agent can report monitoring data to the cloud service (e.g., EDR data, telemetry data, etc. that can be used to determine the presence of a security threat, data indicating that the agent has detected a threat on the system, or both), and the cloud service can provide a security policy for the agent to apply to the system. In some embodiments, a cloud service may not be involved, or the agent may be able to operate without making contact with the cloud service. For example, in some embodiments, security policies may be stored on a system and in response to detecting a threat on the system, detecting that a threat on the system has been resolved, or both, the agent may automatically select and apply a locally stored security policy without communicating with a cloud service. In some embodiments, an arrangement in which an agent communicates with a cloud service to determine security policies to enforce can have certain advantages, while in other embodiments, an approach which does not rely on a network connection can have certain advantages. For example, using local security policies can allow dynamically updating security policies even when a network connection is not available. In some embodiments, using a cloud service in conjunction with an agent can simplify implementation (for example, a single configuration may easily be shared among different devices that may be running different operating systems, revisions to security policies may take immediate or nearly immediate effect, etc. In some embodiments, utilizing a cloud service can result in an agent that consumes fewer resources on a system such as an endpoint.

As described herein, in some embodiments, there can be multiple security policies. For example, there can be different security policies for different types of security threats. In some embodiments, a system may experience more than one threat at the same time. In some embodiments, a cloud service (in the case of an agent communicating with a cloud service) or the agent itself may dynamically generate a policy based on two or more policies. For example, the dynamically generated policy may apply the most restrictive policies from the two or more policies. For example, if a system is subject to both a physical attack and a ransomware attack, a dynamically generated security policy may block USB ports and Bluetooth connections in accordance with a physical attack security policy and may block writes to a local filesystem in accordance with a ransomware security policy.

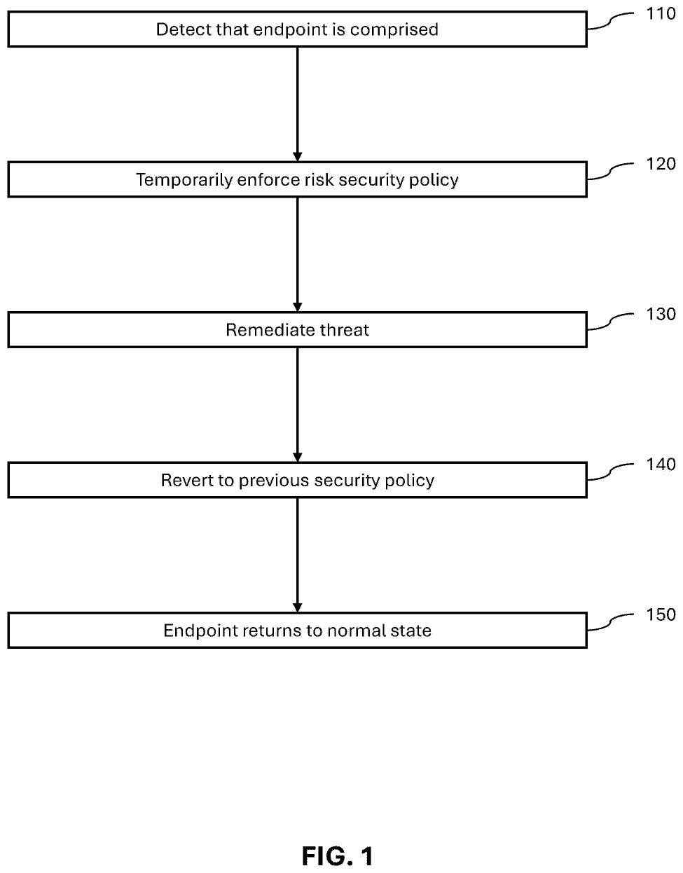

FIG. 1 illustrates a flowchart of an example conditional policy implementation according to some embodiments herein. The process depicted in FIG. 1 can be carried out on computer systems. In some embodiments, a baseline security policy may be defined for an endpoint, a group of endpoints, or all endpoints of an organizational network in a healthy state. In some embodiments, a malware detection system may monitor endpoints, for example, using one or more agents, to verify the security status and detect threats to the endpoints. In some embodiments, one or more endpoints of the system may be compromised or otherwise deemed to be at risk by the detection system. In some embodiments, a separate, different risk security policy may be defined and implemented on any endpoint or group of endpoints deemed to be compromised or at risk by the system. For example, the risk security policy may comprise an increased security level relative to the baseline security policy. In some embodiments, the risk security policy may block network access by the endpoint, may reduce applied exclusions, may block USB or Bluetooth peripherals, and/or increase the monitoring of indicators of compromise (IOCs) (e.g., registry keys, filenames, file hashes, IP addresses, etc.), among others. In some embodiments, upon remediation of the threat or compromise, the baseline security policy may be reimplemented on the previously compromised system. In some embodiments, the entirety of the above process may be completed automatically and dynamically by a conditional policy engine.

At step 110, an agent can detect that a computing system is compromised. For example, the agent can report to a cloud service that the agent has detected a security threat on the computing system, or the agent can report monitoring information to the cloud service, and the cloud service can analyze the monitoring data to determine that a security threat is present on the computing system.

At step 120, the agent can temporarily enforce a risk security policy. For example, the computing system may, under normal operating conditions, operate with a default security policy. The risk security policy can impose additional restrictions on the computing system, additional monitoring on the computing system, and so forth.

At step 130, the threat can be remediated. In some embodiments, the threat can be remediated by anti-malware software, by an AI/ML application, and/or by a security analyst or other information technology professional.

At step 140, the system can automatically revert to the default security policy. For example, the agent may detect that the security threat is no longer present on the computing system (e.g., by analyzing monitoring data or by sending monitoring data to a cloud service for analysis).

At step 150, the computing system can return to its normal state, in which the default security policy is in effect.

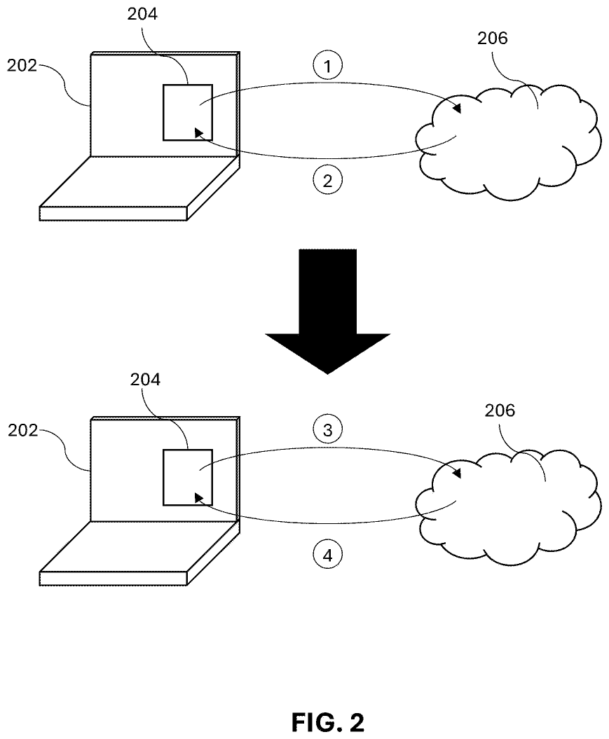

FIG. 2 illustrates an example of automated security policy assignment according to some embodiments. In FIG. 2, an agent 204 running on a computing system 202 is in communication with a cloud service 206 over a network connection. In some embodiments, the computing system 202 can be a laptop, desktop, smartphone, server, cloud server, Kubernetes cluster, virtual machine, container, identity server (e.g., an Active Directory server, Azure AD domain controller, etc.), etc. Starting from an initial state in which the agent 204 is operating with a default security policy, at circle 1, the agent can transmit information to the cloud service 206 indicating that a threat has been detected on the computing system 202. At circle 2, the cloud service 206 can instruct the agent 204 to apply a second, different security policy on the computing system 202. In some embodiments, the second security policy can have one or more configuration differences from the default security policy that causes the second security policy to enforce greater restrictions than the default security policy. In some embodiments, the second security policy can remain in effect until the security threat has been resolved.

At circle 3, the agent 204 can send an indication to the cloud service 206 that the security threat on the computing system 202 has been resolved. At circle 4, the cloud service 206 can transmit instructions to the agent 204 instructing the agent 204 to apply the default security policy or another security policy. For example, in some embodiments, the computing system 202 may be immediately returned to the default security policy after the security threat is resolved. In some embodiments, the computing system 202 may be transitioned to a third security policy after the security threat has been resolved. For example, the third security policy may be more restrictive than the default security policy. The third security policy may be used, for example, if an organization wishes to apply a heightened security policy (for example, with increased monitoring) for a period of time after threat resolution in order to ensure that the threat has actually been resolved.

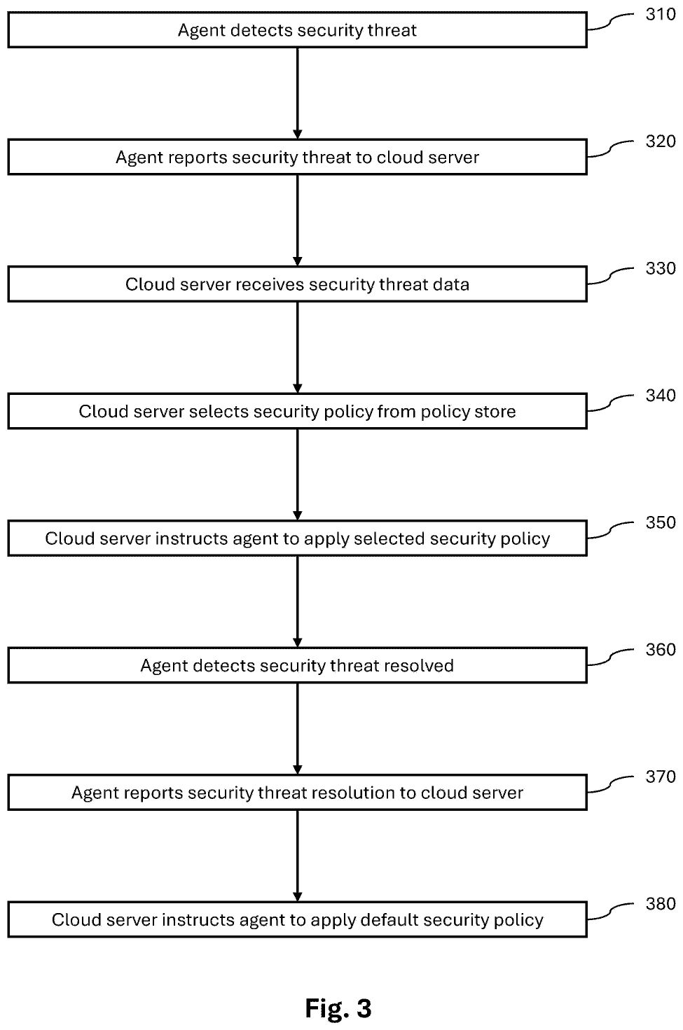

FIG. 3 is a flowchart that illustrates an example process for automatic security policy changes according to some embodiments. The process depicted in FIG. 3 may be run on computer systems.

At step 310, an agent running on a computing system can detect a security threat on the computing system. At step 320, the agent can report the security threat to a cloud service. At step 330, the cloud service can receive security threat information (e.g., monitoring data, a notification that a security threat has been detected, etc.). At step 340, the cloud service can select a security policy from a policy store (e.g., a database that contains or points to one or more security policies). In some embodiments, there can be a single elevated security policy that is applied when a security threat is detected on a computing system. In some embodiments, there can be multiple elevated security policies available, and the security policy to be applied can be based on one or more factors. For example, in some embodiments, security policy selection can depend on the type of security threat. For example, if the threat is a ransomware attack, an elevated security policy may include policies such as restricting writing to attached storage devices. If the threat is a physical unauthorized access attack (e.g., a user is copying large volumes of data from the computing device), an elevated security policy may take actions such as disabling writing to USB flash drives and/or other removable storage media. At step 350, the cloud service can instruct the agent to apply the selected security policy.

At step 360, the agent can detect that the security threat has been resolved. For example, a security analyst may have taken action to remove malware, IP addresses may have been blocked to stop a remote attack, etc. At step 370, the agent can report resolution of the security threat to the cloud service. At step 380, the cloud service can instruct the agent to apply the default security policy.

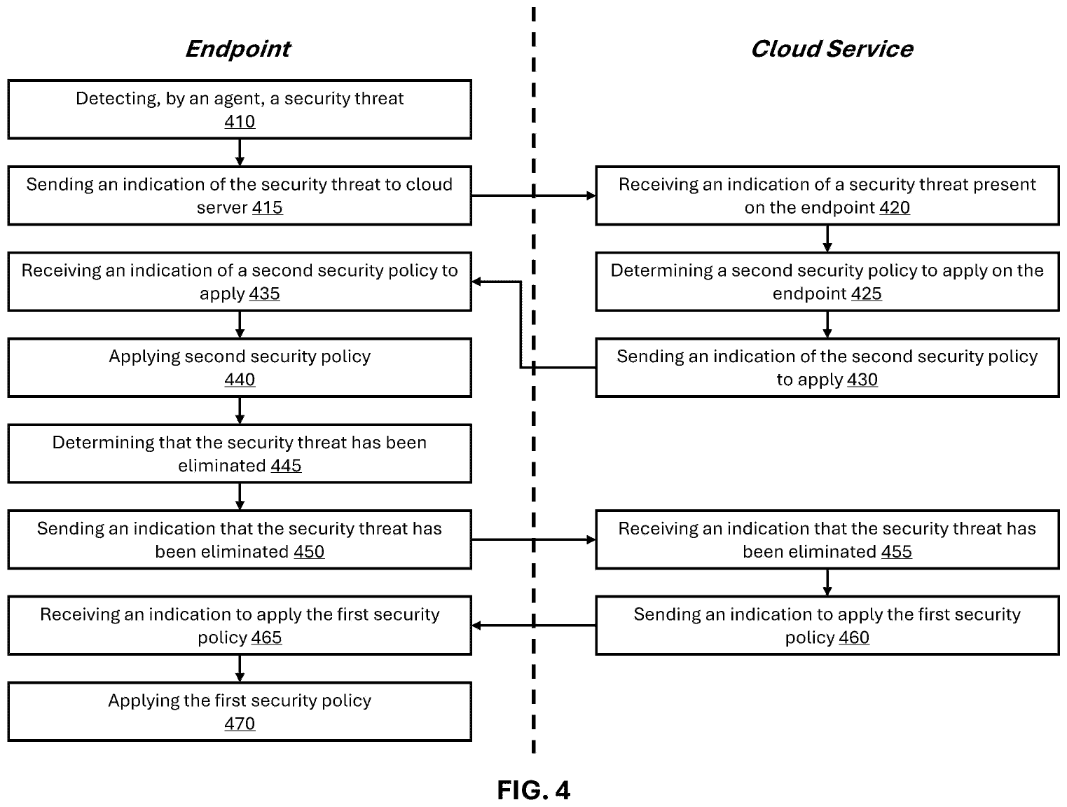

FIG. 4 illustrates an example process that can take place between an endpoint and a cloud service according to some embodiments. At step 410, an agent running on the endpoint can detect a security threat. The endpoint can be operating with a first security policy, which can be, for example, a default security policy for the endpoint. At step 415, the agent can report the threat to the cloud service. At step 420, the cloud service can receive the report of the security threat. At step 425, the cloud service can determine a second security policy to apply on the endpoint. In some embodiments, there can be multiple security policies from which the cloud service selects, for example based on the type of security threat. In some embodiments, there may be only one additional security policy (aside from, for example, a default security policy). At step 430, the cloud service can send instructions to the endpoint to apply the second security policy. In some embodiments, the cloud service may send the second security policy to the endpoint. In some embodiments, the endpoint may already have a copy of the second security policy, and the cloud service may instruct the endpoint to apply the second security policy that is already present on the endpoint.

At step 435, the endpoint can receive the instructions from the cloud service to apply the second security policy. At step 440, the endpoint can apply the second security policy. At step 445, the endpoint can determine that the security threat has been eliminated. For example, a security analyst may have removed malware from the endpoint, some network access of the endpoint may have been eliminated (e.g., one or more domains or IP addresses may have been blocked, one or more ports may have been closed, etc.). At step 450, the endpoint can send an indication to the cloud service that the security threat has been eliminated. At step 455, the cloud service can receive the indication that the security threat has been eliminated. At step 460, the cloud service can instruct the endpoint to apply the first security policy (e.g., to revert to the default security policy). At step 465, the endpoint can receive the instructions to apply the first security policy. At step 470, the endpoint can apply the first security policy.

In some embodiments, an agent running on the endpoint can be configured to automatically revert from the second security policy to the first security policy after determining that the security threat has been eliminated. For example, with reference to FIG. 4, in some embodiments, steps 450-465 may be omitted, and the process can proceed directly from step 455 (determining that the security threat has been eliminated) to step 470 (applying the first security policy).

Some embodiments described above can rely on network connectivity in order to switch from a first security policy to a second security policy. While such reliance may generally not be a problem and can afford significant flexibility in threat monitoring and response, in some cases network disruptions could occur that may prevent an endpoint or other computing system from making contact with a cloud service. For example, in the case of a physical attack, an attacker may disconnect an endpoint from the network (e.g., by switching off Wi-Fi, disconnecting from a Wi-Fi network, unplugging a network cable, etc.), such that the endpoint cannot communicate with a cloud service. Thus, in some embodiments, it can be significant to apply an elevated security policy if an agent running on the endpoint is unable to communicate with the cloud service.

An agent may be unable to communicate with a cloud service for a variety of reasons. For example, if an employee leaves work for the day, they may put their computer to sleep or shut down the computer, in which case the agent may be unable to communicate with the cloud or backend server for a period of time. In some cases, a user may take their laptop home in the evening and may resume work while at home, for example utilizing a virtual private network (VPN) connection. In some cases, an endpoint such as a laptop or desktop may be configured to limit network access unless the endpoint is connected to a VPN. Thus, a problem with a VPN connection may render the agent unable to communicate with the cloud service.

Accordingly, depending upon an organization's risk tolerance, an organization may or may not choose to apply elevated security policies in cases where the endpoint is unable to communicate with the cloud service. In some embodiments, an organization may configure the agent so that elevated security policies are only enabled if unusual network connectivity issues occur. For example, if an endpoint is unable to communicate with the cloud service for more than 24 hours during the work week, this may indicate a security threat. However, if an endpoint doesn't communicate with the cloud or backend server for 24 hours during the weekend, this may simply indicate that a worker was not working over the weekend, in which case an organization may choose not to apply elevated security policies. In some embodiments, organizations can configure conditions under which elevated security policies will be enabled locally (e.g., automatically enabled by an agent running on the endpoint).

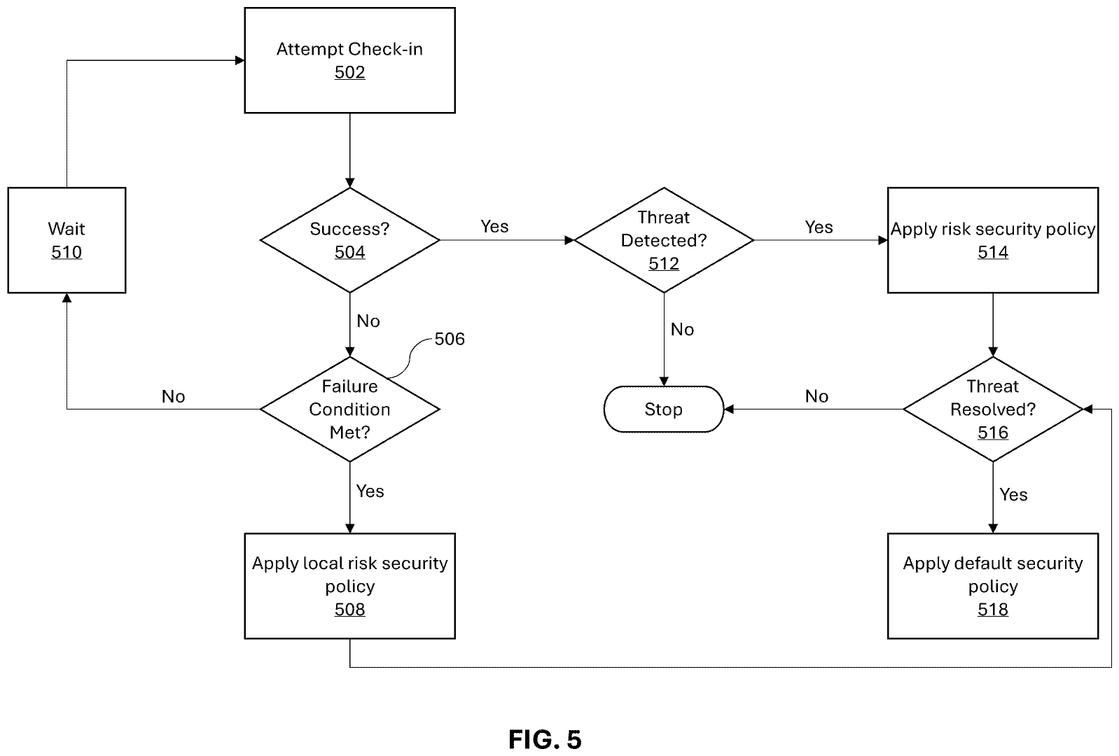

FIG. 5 illustrates an example process that can be run by an agent on a computing system such as a desktop, laptop, smartphone, server, identity server, etc., according to some embodiments. At step 502, the agent can attempt to check in with a cloud service. At decision point 504, if the check in was not successful, the agent can proceed to decision point 506. At decision point 506, the agent can determine if one or more failure conditions are met (e.g., no check in for more than a threshold amount of time, security threat detected by the agent, etc.). If the one or more failure conditions are satisfied, the agent can apply a local risk security policy at step 508. If the one or more failure conditions are not satisfied, the agent can wait at step 510 before attempting to check in with the cloud or backend server again after a period of time. In some embodiments, there can be one failure condition, two failure conditions, three failure conditions, etc. The number of failure conditions is not necessarily limited. In some embodiments, the local risk security policy can be applied if all of the conditions are satisfied, if one of the conditions is satisfied, etc. Any combination of logical operations can be used to determine if the local risk security policy should be applied. For example, “(A and B) or C” could be used to mean that the local risk security policy is triggered if both A and B are satisfied or if C is satisfied. The local risk security policy can remain in effect until, at decision 516, the threat is resolved. If the threat is resolved, the agent can apply a default security policy at step 518.

If, at decision point 504, the check-in was successful, the agent can proceed to decision 512 and determine if a threat was detected. For example, the agent can send monitoring data (e.g., EDR data, telemetry data, etc.) to the cloud service and can receive a response indicating that a threat was detected or that a threat was not detected. If no threat was detected, the process can stop. For example, instead of taking further action, the agent can continue monitoring the system. If, at decision 512, a threat was detected, the agent can, at step 514, apply a risk security policy. The risk security policy can impose additional security measures on the system as described herein. At decision 516, the agent can determine if the security threat has been resolved. If not, the process can stop, and the agent can continue to enforce the risk security policy. In some embodiments, the agent can continue to monitor the system. If, at decision 516, the security threat has been resolved, the agent can revert to the default security policy.

### Computer Systems

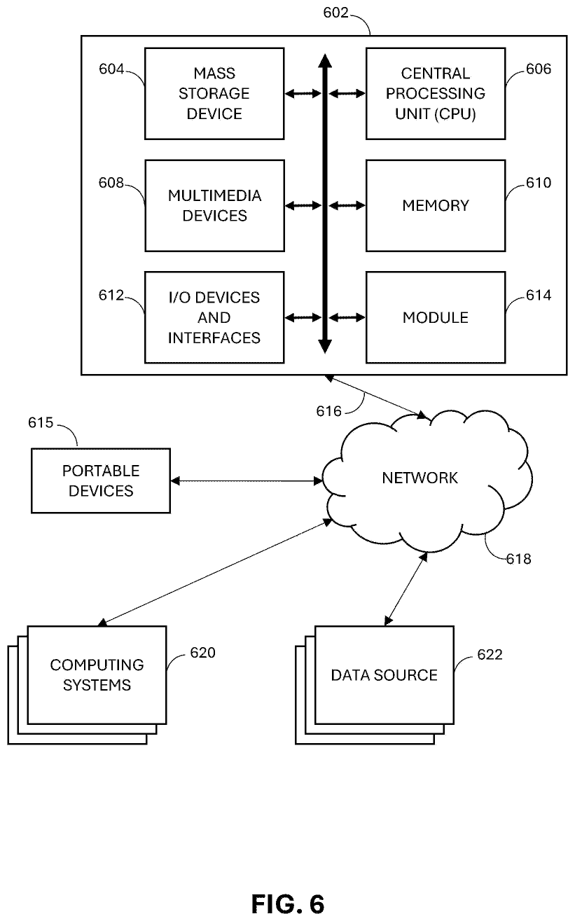

FIG. 6 is a block diagram depicting an embodiment of a computer hardware system configured to run software for implementing one or more embodiments disclosed herein.

In some embodiments, the systems, processes, and methods described herein are implemented using a computing system, such as the one illustrated in FIG. 6. The example computer system 602 is in communication with one or more computing systems 620 and/or one or more data sources 622 via one or more networks 618. While FIG. 6 illustrates an embodiment of a computing system 602, it is recognized that the functionality provided for in the components and modules of computer system 602 may be combined into fewer components and modules, or further separated into additional components and modules.

The computer system 602 can comprise a conditional policy engine 614 that carries out the functions, methods, acts, and/or processes described herein. The conditional policy engine 614 is executed on the computer system 602 by a central processing unit 606 discussed further below.

In general, the word “module,” as used herein, refers to logic embodied in hardware or firmware or to a collection of software instructions, having entry and exit points. Modules are written in a program language, such as JAVA, C or C++, Python, or the like. Software modules may be compiled or linked into an executable program, installed in a dynamic link library, or may be written in an interpreted language such as BASIC, PERL, LUA, or Python. Software modules may be called from other modules or from themselves, and/or may be invoked in response to detected events or interruptions. Modules implemented in hardware include connected logic units such as gates and flip-flops, and/or may include programmable units, such as programmable gate arrays or processors.

Generally, the modules described herein refer to logical modules that may be combined with other modules or divided into sub-modules despite their physical organization or storage. The modules are executed by one or more computing systems and may be stored on or within any suitable computer readable medium or implemented in-whole or in-part within special designed hardware or firmware. Not all calculations, analysis, and/or optimization require the use of computer systems, though any of the above-described methods, calculations, processes, or analyses may be facilitated through the use of computers. Further, in some embodiments, process blocks described herein may be altered, rearranged, combined, and/or omitted.

The computer system 602 includes one or more processing units (CPU) 606, which may comprise a microprocessor. The computer system 602 further includes a physical memory 610, such as random-access memory (RAM) for temporary storage of information, a read only memory (ROM) for permanent storage of information, and a mass storage device 604, such as a backing store, hard drive, rotating magnetic disks, solid state disks (SSD), flash memory, phase-change memory (PCM), 3D XPoint memory, diskette, or optical media storage device. Alternatively, the mass storage device may be implemented in an array of servers. Typically, the components of the computer system 602 are connected to the computer using a standards-based bus system. The bus system can be implemented using various protocols, such as Peripheral Component Interconnect (PCI), Micro Channel, SCSI, Industrial Standard Architecture (ISA) and Extended ISA (EISA) architectures.

The computer system 602 includes one or more input/output (I/O) devices and interfaces 612, such as a keyboard, mouse, touch pad, and printer. The I/O devices and interfaces 612 can include one or more display devices, such as a monitor, that allows the visual presentation of data to a user. More particularly, a display device provides for the presentation of GUIs as application software data, and multi-media presentations, for example. The I/O devices and interfaces 612 can also provide a communications interface to various external devices. The computer system 602 may comprise one or more multi-media devices 608, such as speakers, video cards, graphics accelerators, and microphones, for example.

The computer system 602 may run on a variety of computing devices, such as a server, a Windows server, a Structure Query Language server, a Unix Server, a personal computer, a laptop computer, and so forth. In other embodiments, the computer system 602 may run on a cluster computer system, a mainframe computer system and/or other computing system suitable for controlling and/or communicating with large databases, performing high volume transaction processing, and generating reports from large databases. The computing system 602 is generally controlled and coordinated by an operating system software, such as Windows XP, Windows Vista, Windows 7, Windows 8, Windows 10, Windows 11, Windows Server, Unix, Linux (and its variants such as Debian, Linux Mint, Fedora, and Red Hat), SunOS, Solaris, Blackberry OS, z/OS, iOS, macOS, or other operating systems, including proprietary operating systems. Operating systems control and schedule computer processes for execution, perform memory management, provide file system, networking, and I/O services, and provide a user interface, such as a graphical user interface (GUI), among other things.

The computer system 602 illustrated in FIG. 6 is coupled to a network 618, such as a LAN, WAN, or the Internet via a communication link 616 (wired, wireless, or a combination thereof). Network 618 communicates with various computing devices and/or other electronic devices. Network 618 is communicating with one or more computing systems 620 and one or more data sources 622. The conditional policy engine 614 may access or may be accessed by computing systems 620 and/or data sources 622 through a web-enabled user access point. Connections may be a direct physical connection, a virtual connection, and other connection type. The web-enabled user access point may comprise a browser module that uses text, graphics, audio, video, and other media to present data and to allow interaction with data via the network 618.

Access to the conditional policy engine 614 of the computer system 602 by computing systems 620 and/or by data sources 622 may be through a web-enabled user access point such as the computing systems' 620 or data source's 622 personal computer, cellular phone, smartphone, laptop, tablet computer, e-reader device, audio player, or another device capable of connecting to the network 618. Such a device may have a browser module that is implemented as a module that uses text, graphics, audio, video, and other media to present data and to allow interaction with data via the network 618.

The output module may be implemented as a combination of an all-points addressable display such as a cathode ray tube (CRT), a liquid crystal display (LCD), a plasma display, or other types and/or combinations of displays. The output module may be implemented to communicate with input devices 612 and they also include software with the appropriate interfaces which allow a user to access data through the use of stylized screen elements, such as menus, windows, dialogue boxes, tool bars, and controls (for example, radio buttons, check boxes, sliding scales, and so forth). Furthermore, the output module may communicate with a set of input and output devices to receive signals from the user.

The input device(s) may comprise a keyboard, roller ball, pen and stylus, mouse, trackball, voice recognition system, or pre-designated switches or buttons. The output device(s) may comprise a speaker, a display screen, a printer, or a voice synthesizer. In addition, a touch screen may act as a hybrid input/output device. In another embodiment, a user may interact with the system more directly such as through a system terminal connected to the score generator without communications over the Internet, a WAN, or LAN, or similar network.

In some embodiments, the system 602 may comprise a physical or logical connection established between a remote microprocessor and a mainframe host computer for the express purpose of uploading, downloading, or viewing interactive data and databases online in real time. The remote microprocessor may be operated by an entity operating the computer system 602, including the client server systems or the main server system, an/or may be operated by one or more of the data sources 622 and/or one or more of the computing systems 620. In some embodiments, terminal emulation software may be used on the microprocessor for participating in the micro-mainframe link.

In some embodiments, computing systems 620 who are internal to an entity operating the computer system 602 may access the conditional policy engine 614 internally as an application or process run by the CPU 606.

In some embodiments, one or more features of the systems, methods, and devices described herein can utilize a URL and/or cookies, for example for storing and/or transmitting data or user information. A Uniform Resource Locator (URL) can include a web address and/or a reference to a web resource that is stored on a database and/or a server. The URL can specify the location of the resource on a computer and/or a computer network. The URL can include a mechanism to retrieve the network resource. The source of the network resource can receive a URL, identify the location of the web resource, and transmit the web resource back to the requestor. A URL can be converted to an IP address, and a Domain Name System (DNS) can look up the URL and its corresponding IP address. URLs can be references to web pages, file transfers, emails, database accesses, and other applications. The URLs can include a sequence of characters that identify a path, domain name, a file extension, a host name, a query, a fragment, scheme, a protocol identifier, a port number, a username, a password, a flag, an object, a resource name and/or the like. The systems disclosed herein can generate, receive, transmit, apply, parse, serialize, render, and/or perform an action on a URL.

A cookie, also referred to as an HTTP cookie, a web cookie, an internet cookie, and a browser cookie, can include data sent from a website and/or stored on a user's computer. This data can be stored by a user's web browser while the user is browsing. The cookies can include useful information for websites to remember prior browsing information, such as a shopping cart on an online store, clicking of buttons, login information, and/or records of web pages or network resources visited in the past. Cookies can also include information that the user enters, such as names, addresses, passwords, credit card information, etc. Cookies can also perform computer functions. For example, authentication cookies can be used by applications (for example, a web browser) to identify whether the user is already logged in (for example, to a web site). The cookie data can be encrypted to provide security for the consumer. Tracking cookies can be used to compile historical browsing histories of individuals. Systems disclosed herein can generate and use cookies to access data of an individual. Systems can also generate and use JSON web tokens to store authenticity information, HTTP authentication as authentication protocols, IP addresses to track session or identity information, URLs, and the like.

The computing system 602 may include one or more internal and/or external data sources (for example, data sources 622). In some embodiments, one or more of the data repositories and the data sources described above may be implemented using a relational database, such as Sybase, Oracle, CodeBase, DB2, PostgreSQL, and Microsoft® SQL Server as well as other types of databases such as, for example, a NoSQL database (for example, Couchbase, Cassandra, or MongoDB), a flat file database, an entity-relationship database, an object-oriented database (for example, InterSystems Cache), a cloud-based database (for example, Amazon RDS, Azure SQL, Microsoft Cosmos DB, Azure Database for MySQL, Azure Database for MariaDB, Azure Cache for Redis, Azure Managed Instance for Apache Cassandra, Google Bare Metal Solution for Oracle on Google Cloud, Google Cloud SQL, Google Cloud Spanner, Google Cloud Big Table, Google Firestore, Google Firebase Realtime Database, Google Memorystore, Google MongoDB Atlas, Amazon Aurora, Amazon DynamoDB, Amazon Redshift, Amazon ElastiCache, Amazon MemoryDB for Redis, Amazon DocumentDB, Amazon Keyspaces, Amazon Neptune, Amazon Timestream, or

The computer system 602 may also access one or more databases 622. The databases 622 may be stored in a database or data repository. The computer system 602 may access the one or more databases 622 through a network 618 or may directly access the database or data repository through I/O devices and interfaces 612. The data repository storing the one or more databases 622 may reside within the computer system 602.

### ADDITIONAL EMBODIMENTS

In the foregoing specification, the invention has been described with reference to specific embodiments thereof. It will, however, be evident that various modifications and changes may be made thereto without departing from the broader spirit and scope of the invention. The specification and drawings are, accordingly, to be regarded in an illustrative rather than restrictive sense.

Indeed, although this invention has been disclosed in the context of certain embodiments and examples, it will be understood by those skilled in the art that the invention extends beyond the specifically disclosed embodiments to other alternative embodiments and/or uses of the invention and obvious modifications and equivalents thereof. In addition, while several variations of the embodiments of the invention have been shown and described in detail, other modifications, which are within the scope of this invention, will be readily apparent to those of skill in the art based upon this disclosure. It is also contemplated that various combinations or sub-combinations of the specific features and aspects of the embodiments may be made and still fall within the scope of the invention. It should be understood that various features and aspects of the disclosed embodiments can be combined with, or substituted for, one another in order to form varying modes of the embodiments of the disclosed invention. Any methods disclosed herein need not be performed in the order recited. Thus, it is intended that the scope of the invention herein disclosed should not be limited by the particular embodiments described above.

It will be appreciated that the systems and methods of the disclosure each have several innovative aspects, no single one of which is solely responsible or required for the desirable attributes disclosed herein. The various features and processes described above may be used independently of one another or may be combined in various ways. All possible combinations and subcombinations are intended to fall within the scope of this disclosure.

Certain features that are described in this specification in the context of separate embodiments also may be implemented in combination in a single embodiment. Conversely, various features that are described in the context of a single embodiment also may be implemented in multiple embodiments separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination. No single feature or group of features is necessary or indispensable to each and every embodiment.

It will also be appreciated that conditional language used herein, such as, among others, “can,” “could,” “might,” “may,” “e.g.,” and the like, unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without author input or prompting, whether these features, elements and/or steps are included or are to be performed in any particular embodiment. The terms “comprising,” “including,” “having,” and the like are synonymous and are used inclusively, in an open-ended fashion, and do not exclude additional elements, features, acts, operations, and so forth. In addition, the term “or” is used in its inclusive sense (and not in its exclusive sense) so that when used, for example, to connect a list of elements, the term “or” means one, some, or all of the elements in the list. In addition, the articles “a,” “an,” and “the” as used in this application and the appended claims are to be construed to mean “one or more” or “at least one” unless specified otherwise. Similarly, while operations may be depicted in the drawings in a particular order, it is to be recognized that such operations need not be performed in the particular order shown or in sequential order, or that all illustrated operations be performed, to achieve desirable results. Further, the drawings may schematically depict one or more example processes in the form of a flowchart. However, other operations that are not depicted may be incorporated in the example methods and processes that are schematically illustrated. For example, one or more additional operations may be performed before, after, simultaneously, or between any of the illustrated operations. Additionally, the operations may be rearranged or reordered in other embodiments. In certain circumstances, multitasking and parallel processing may be advantageous. Moreover, the separation of various system components in the embodiments described above should not be understood as requiring such separation in all embodiments, and it should be understood that the described program components and systems may generally be integrated together in a single software product or packaged into multiple software products. Additionally, other embodiments are within the scope of the following claims. In some cases, the actions recited in the claims may be performed in a different order and still achieve desirable results.

Further, while the methods and devices described herein may be susceptible to various modifications and alternative forms, specific examples thereof have been shown in the drawings and are herein described in detail. It should be understood, however, that the invention is not to be limited to the particular forms or methods disclosed, but, to the contrary, the invention is to cover all modifications, equivalents, and alternatives falling within the spirit and scope of the various implementations described and the appended claims. Further, the disclosure herein of any particular feature, aspect, method, property, characteristic, quality, attribute, element, or the like in connection with an implementation or embodiment can be used in all other implementations or embodiments set forth herein. Any methods disclosed herein need not be performed in the order recited. The methods disclosed herein may include certain actions taken by a practitioner; however, the methods can also include any third-party instruction of those actions, either expressly or by implication. The ranges disclosed herein also encompass any and all overlap, sub-ranges, and combinations thereof. Language such as “up to,” “at least,” “greater than,” “less than,” “between,” and the like includes the number recited. Numbers preceded by a term such as “about” or “approximately” include the recited numbers and should be interpreted based on the circumstances (e.g., as accurate as reasonably possible under the circumstances, for example ±5%, ±10%, ±15%, etc.). For example, “about 3.5 mm” includes “3.5 mm.” Phrases preceded by a term such as “substantially” include the recited phrase and should be interpreted based on the circumstances (e.g., as much as reasonably possible under the circumstances). For example, “substantially constant” includes “constant.” Unless stated otherwise, all measurements are at standard conditions including temperature and pressure.

As used herein, a phrase referring to “at least one of” a list of items refers to any combination of those items, including single members. As an example, “at least one of: A, B, or C” is intended to cover: A, B, C, A and B, A and C, B and C, and A, B, and C. Conjunctive language such as the phrase “at least one of X, Y and Z,” unless specifically stated otherwise, is otherwise understood with the context as used in general to convey that an item, term, etc. may be at least one of X, Y or Z. Thus, such conjunctive language is not generally intended to imply that certain embodiments require at least one of X, at least one of Y, and at least one of Z to each be present. The headings provided herein, if any, are for convenience only and do not necessarily affect the scope or meaning of the devices and methods disclosed herein.

Accordingly, the claims are not intended to be limited to the embodiments shown herein but are to be accorded the widest scope consistent with this disclosure, the principles and the novel features disclosed herein.

What is claimed is:

1. A computer-implemented method for automatically applying a security policy in response to a security threat comprising:
detecting, by an agent running on a first computing system, information indicative of a security threat, wherein the first computing system is operating with a first security policy;
sending, from the first computing system to a second computing system via a network connection, an indication of the security threat;
receiving, by the first computing system from the second computing system via the network connection, an indication of a second security policy to apply; and
applying, by the agent, the second security policy to the first computing system.

2. The computer-implemented method of claim 1, further comprising:
determining, by the agent running on the first computing system, that the security threat has been eliminated;
sending, from the first computing system to the second computing system via the network connection, an indication that the security threat has been eliminated;
receiving, by the first computing system from the second computing system via the network connection, an indication to apply the first security policy; and
applying, by the agent on the first computing system, the first security policy.

3. The computer-implemented method of claim 1, wherein the indication of the second security policy to apply comprises the second security policy.

4. The computer-implemented method of claim 1, wherein the indication of the second security policy to apply comprises an identifier of the second security policy, wherein the second security policy is stored on the first computing system.

5. The computer-implemented method of claim 1, wherein the information indicative of a security threat comprises information indicative of a first security threat and information indicative of a second security threat, wherein the second security policy is generated by the second computing system based on a third security policy associated with the first security threat and a fourth security policy associated with the second security threat.

6. The computer-implemented method of claim 1, wherein the second security policy comprises a group policy object.

7. The computer-implemented method of claim 1, wherein the information indicative of the security threat comprises monitoring data, and wherein the second computing system is configured to analyze the monitoring data and determine that a security threat is present on the first computing system.

8. The computer-implemented method of claim 1, wherein the information indicative of the security threat comprises an indication that the agent has detected a security threat on the first computing system, wherein the agent is configured to analyze monitoring data and determine that a security threat is present on the first computing system.

9. A computer-implemented method for automatically applying a security policy in response to a security threat comprising:
receiving, by a first computing system from a second computing system via a network connection, information indicative of a security threat present on the second computing system, wherein the second computing system is operating with a first security policy;
determining, by the first computing system, a second security policy to apply on the second computing system; and
sending, from the first computing system to the second computing system via the network connection, an indication of the second security policy to apply.

10. The computer-implemented method of claim 9, further comprising:
receiving, by the first computing system from the second computing system via the network connection, an indication that the security threat has been eliminated; and
sending, from the first computing system to the second computing system via the network connection, an indication to apply the first security policy.

11. The computer-implemented method of claim 9, wherein the indication of the second security policy to apply comprises the second security policy.

12. The computer-implemented method of claim 9, wherein the indication of the second security policy to apply comprises an identifier of the second security policy, wherein the second security policy is stored on the second computing system.

13. The computer-implemented method of claim 9, wherein the information indicative of a security threat comprises information indicative of a first security threat and information indicative of a second security threat, wherein the computer-implemented method further comprises:
determining, by the first computing system, a third security policy in response to the first security threat;
determining, by the first computing system, a fourth security policy in response to the second security threat; and
generating, by the first computing system, the second security policy based on the third security policy and the fourth security policy.

14. The computer-implemented method of claim 9, wherein the second security policy comprises a group policy object.

15. The computer-implemented method of claim 9, wherein the information indicative of the security threat comprises monitoring data, and wherein the first computing system is configured to analyze the monitoring data and determine that a security threat is present on the second computing system.

16. The computer-implemented method of claim 9, wherein the information indicative of the security threat comprises an indication that an agent running on the second computing system has detected a security threat on the second computing system, wherein the agent is configured to analyze monitoring data and determine that a security threat is present on the second computing system.

17. A computer-readable medium storing instructions that, when executed by a computer, cause the computer to perform a method comprising:
detecting, by an agent running on a first computing system, information indicative of a security threat, wherein the first computing system is operating with a first security policy;
sending, from the first computing system to a second computing system via a network connection, an indication of the security threat;
receiving, by the first computing system from the second computing system via the network connection, an indication of a second security policy to apply; and
applying, by the agent, the second security policy to the first computing system.

18. The computer-readable medium of claim 17, wherein the method further comprises:
determining, by the agent running on the first computing system, that the security threat has been eliminated;
sending, from the first computing system to the second computing system via the network connection, an indication that the security threat has been eliminated;
receiving, by the first computing system from the second computing system via the network connection, an indication to apply the first security policy; and
applying, by the agent on the first computing system, the first security policy.

19. The computer-readable medium of claim 17, wherein the information indicative of the security threat comprises monitoring data, and wherein the second computing system is configured to analyze the monitoring data and determine that a security threat is present on the first computing system.

20. The computer-readable medium of claim 17, wherein the information indicative of the security threat comprises an indication that the agent has detected a security threat on the first computing system, wherein the agent is configured to analyze monitoring data and determine that a security threat is present on the first computing system.
